(19) United States
(12) Patent Application Publication
(10) Pub. No.: US 2002/0152462 A1
(43) Pub. Date: Oct. 17, 2002

(54) Method and apparatus for a frame work for structured overlay of real time graphics

(76) Inventors: Michael Hoch, San Jose, CA (US); Hubert Le Van Gong, Santa Clara, CA (US); Richter A. Rafey, Santa Clara, CA (US); Adam Brownstein, New York, NY (US)

Correspondence Address: OPPENHEIMER WOLFF & DONNELLY, P. O. BOX 10356, PALO ALTO, CA, 94303, US

(21) Appl. No.: 09/942,255

(22) Filed: Aug. 28, 2001

Related U.S. Application Data
(60) Provisional application No. 60/228,926, filed on Aug. 29, 2000.
(60) Provisional application No. 60/311,301, filed on Aug. 10, 2001.

(51) Int. Cl. G06F 13/00; H04N 5/445; G06F 3/00

(52) U.S. Cl. 725/37

(57) ABSTRACT

An apparatus and a method of automatically displaying multiple assets on a screen comprising receiving a composite video feed, the composite video feed including a plurality of assets, obtaining user preference data to determine which of the plurality of assets to display on each of a plurality of display regions, aligning and scaling assets to be displayed in corresponding display regions according to the obtained user preference data, and displaying the aligned and scaled assets with the elementary video feed.

### CROSS REFERENCE TO RELATED APPLICATIONS:

The present application claims priority from the U.S. provisional application No. 60/228,926 entitled “STRUCTURED OVERLAYS—A FRAMEWORK FOR ITV” filed Aug. 29, 2000, and application No. 60/311,301, entitled “METHOD AND APPARATUS FOR DISTORTION CORRECTION AND DISPLAYING ADD-ON GRAPHICS FOR REAL TIME GRAPHICS” filed Aug. 10, 2001, by the same inventor which is herein incorporated by reference.

### FIELD OF THE INVENTION

The present invention relates generally to audio/visual content, and more particularly to an apparatus and method for automatic layout using meta-tags for multiple camera view while accounting for user preferences.

### BACKGROUND OF THE INVENTION

Digital television (DTV) allows simultaneous transmission of data along with traditional AV content. Digital television broadcasts now reach tens of millions of receivers worldwide. In Europe, Asia and the US, digital satellite television and the digital cable television have been available for several years and have a growing viewer base. In the U.S., the Federal Communication Commission has mandated a transition period from analog NTSC over-the-air broadcast to its digital successor, ATSC, by the year 2006.

The current generation of DTV receivers, primarily cable and satellite set-top-boxes (STB), generally offer limited resources to applications. From a manufacturer's perspective, the goal has been building low-cost receivers comprised of dedicated hardware for handling the incoming MPEG-2 transport stream; tuning and demodulating the broadcast signal, demultiplexing and possibly decrypting (e.g., for pay-per-view) the transport stream, and decoding the AV elementary streams. The focus has been on the STB as an AV receiver rather than a general-purpose platform for downloaded applications and services. However, the next generation of DTV receivers will be more flexible for application development. Receivers are becoming more powerful through the use of faster processors, larger memory, 3 dimensional (3-D) graphics hardware and disk storage.

Most digital television broadcast services, whether satellite, cable, or terrestrial, are bases on the MPEG-2 standard. In addition to specifying audio/video encoding, MPEG-2 defines a transport stream format consisting of a multiplex of elementary streams. The elementary streams can contain compressed audio or video content, “program specific information: describing the structure of the transport stream, and arbitrary data. Standards such as DSM-CC and the more recent ATSC data broadcast standard give ways of placing IP datagrams in elementary data streams.

The expanding power of STB receivers and the ability to transmit data along with the AV transmission has allowed for the possibility of changing television viewing by moving control of broadcast enhancements from the studio for mass presentation into the living room for personalized consumption. The goal of allowing viewer interactions has become an achievable goal. Therefore, there is a need for a method and apparatus allowing user interactivity in molding the broadcast presentation, and specifically allowing viewer input in the presentation of the assets transmitted along with the AV signal.

### SUMMARY OF THE PRESENT INVENTION

Briefly, one aspect of the present invention is a method of automatically displaying multiple assets on a screen comprising receiving a composite video feed, the composite video feed including a plurality of assets, obtaining user preference data to determine which of the plurality of assets to display on each of a plurality of display regions, aligning and scaling assets to be displayed in corresponding display regions according to the obtained user preference data, and displaying the aligned and scaled assets with the elementary video feed.

The advantages of the present invention will become apparent to those skilled in the art upon a reading of the following descriptions and study of the various figures of the drawings.

### BRIEF DESCRIPTION OF THE DRAWINGS

FIG. 1 illustrates a representative transmission and reception system for the present invention;

FIG. 2 is a block diagram of one embodiment for the transmission and reception system for a digital television;

FIG. 3 is an illustrative example of the data communication between the transmission and reception systems in a Digital Television (DTV) system;

FIG. 4 is a flow diagram of one embodiment for the generation of a composite broadcast signal;

FIG. 5 is a diagram of one embodiment for the recovery of a composite broadcast signal illustration of the data flow on the receiver side;

FIG. 6 is an example of one embodiment of the use of meta-data 52 for region definitions;

FIG. 7 is one embodiment for representative region definition layout for possible overlaying of assets on the live video feed;

FIG. 8 shows some examples of display renderings of some possible assets within the in a car race scenario broadcast;

FIG. 9 is an example of a display rendering of the effect of the user preferences on the displaying of assets;

FIG. 10 is another example of a display rendering of the effect of the user preferences on the displaying of assets

### DETAILED DESCRIPTION OF THE PREFERRED EMBODIMENT

Digital Television (DTV) is an area where viewer interaction is expected to become increasingly prevalent in the next few years. Digital TV allows simultaneous transmission of data along with traditional AV content. It provides an inexpensive and high bandwidth data pipe that enables new forms of interactive television and also new types of games, and other applications.

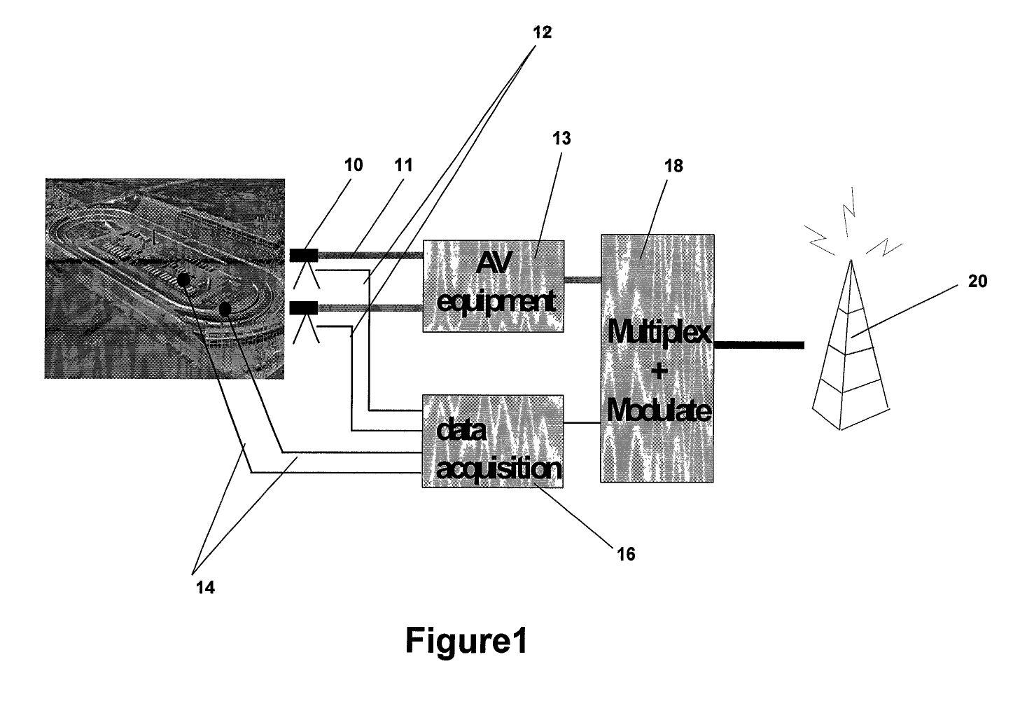

FIG. 1 illustrates a data acquisition and transmission system for a typical Digital Television system. In this illustrative example of a car-racing event, the Audio Video (AV) elementary stream is generated using several cameras 10 that are capturing the live event and feeding the AV equipment 13. Instrumentation data 12 is also collected on each camera and input to the data acquisition unit 16. Concurrently, sensors 14 collect various performance data such as each racecar's speed and engine RPM, and feed the data to the data acquisition unit 16. Furthermore, in a car-racing event such as the one illustrated in the present example, the position of each racecar may be tracked using a Global Positioning Satellite (GPS system), and the positional data on the individual cars 14 is fed to the data acquisition unit 16. The collected data of each racecar may be used on the receiver side to create viewer specific assets, based on that viewer's input. The term assets as used henceforth refers to the event related data transmitted down stream to the viewer's receiver and used to display various windows alongside the AV signal. The data collected by the data acquisition module 16 includes positional and instrumentation data 12 of each of the cameras 10 covering the race, as well as positional and instrumentation data 14 on the each racecar. The AV signal and the corresponding data are multiplexed and modulated by module 18 and transmitted via a TV signal transmitter 20.

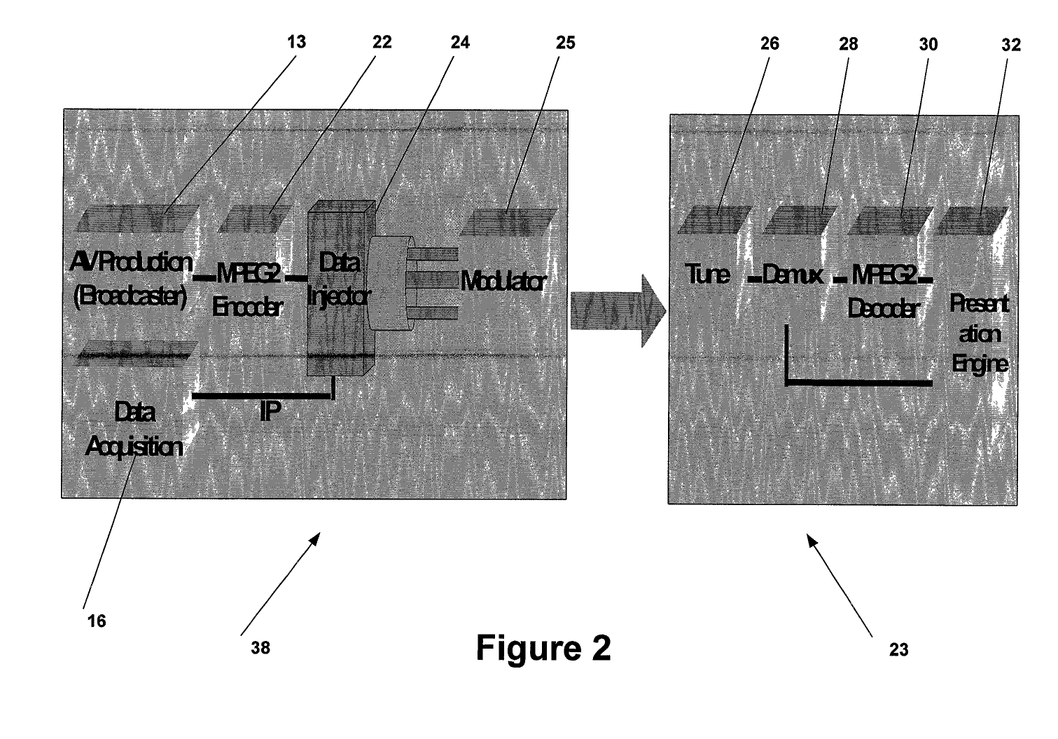

FIG. 2 is a block diagram of one embodiment for the transmission and reception system for a digital television. At the AV signals from the AV production unit 13 (broadcaster) are fed into an MPEG-2 encoder 22 which compresses the AV data based on an MPEG-2 standard. In one embodiment, digital television broadcast services, whether satellite, cable or terrestrial transmission are based on the MPEG-2 standard. In addition to specifying audio and video encoding, MPEG-2 defines a transport stream format consisting of a multiplex of elementary streams. The elementary streams may contain compressed audio or video content, program specific information describing the structure of the transport stream, and arbitrary data. It will be appreciated by one skilled in the art that the teachings of the present invention is not limited to an implementation based on an MPEG-2 standard. Alternatively, the present invention may be implemented using any standard such as MPEG-4, DSM-CC or the Advanced Television System Committee (ATSC) standard that allows for ways of placing IP datagrams in elementary streams. The generated and compressed AV data out of the MPEG-2 encoder is inputted into a data injector 24, which combines the AV signals with the corresponding instrumentation data coming from the data acquisition unit 16.

The data acquisition module 16 handles the various real-time data sources made available to the broadcaster. In the example used with the present embodiment, the data acquisition module 16 obtains the camera tracking, car tracking , car telemetry and standings data feeds and converts these into Internet Protocol (IP) based packets which are then sent to the data injector 24. The data injector 24 receives the IP packets and encapsulates them in an elementary stream that is multiplexed with the AV elementary streams. The resulting transport stream is then modulated by the modulator 25 and transmitted to receiver devices via cable, satellite or terrestrial broadcast.

Typically, DTV receiver tunes to a DTV signal, demodulates and demultiplexes the incoming transport stream, decodes the A/V elementary streams, and outputs the result. A DTV receiver is “data capable” if it can in addition extract application data from the elementary streams. The data capable DTV receiver is the target platform for the system and method of the present invention. These data capable DTV receivers can be realized in many ways: a digital Set Top Box (STB) receiver that connects to a television monitor, an integrated receiver and display, or a PC with a DTV card. In one embodiment, composition engine based on a declarative representation language such as an extended version of the Virtual Reality Markup Language (VRML) may be used to process the incoming data along with the elementary data stream, and render the graphics desired.

It would be apparent to one skilled in the art that any number of declarative representation languages including but not limited to languages such as HTML and XML may be used to practice the present invention. VRML is a web-oriented declarative markup language well suited for 2D/3D graphics generation and thus it is a suitable platform for implementing the teaching of the present invention.

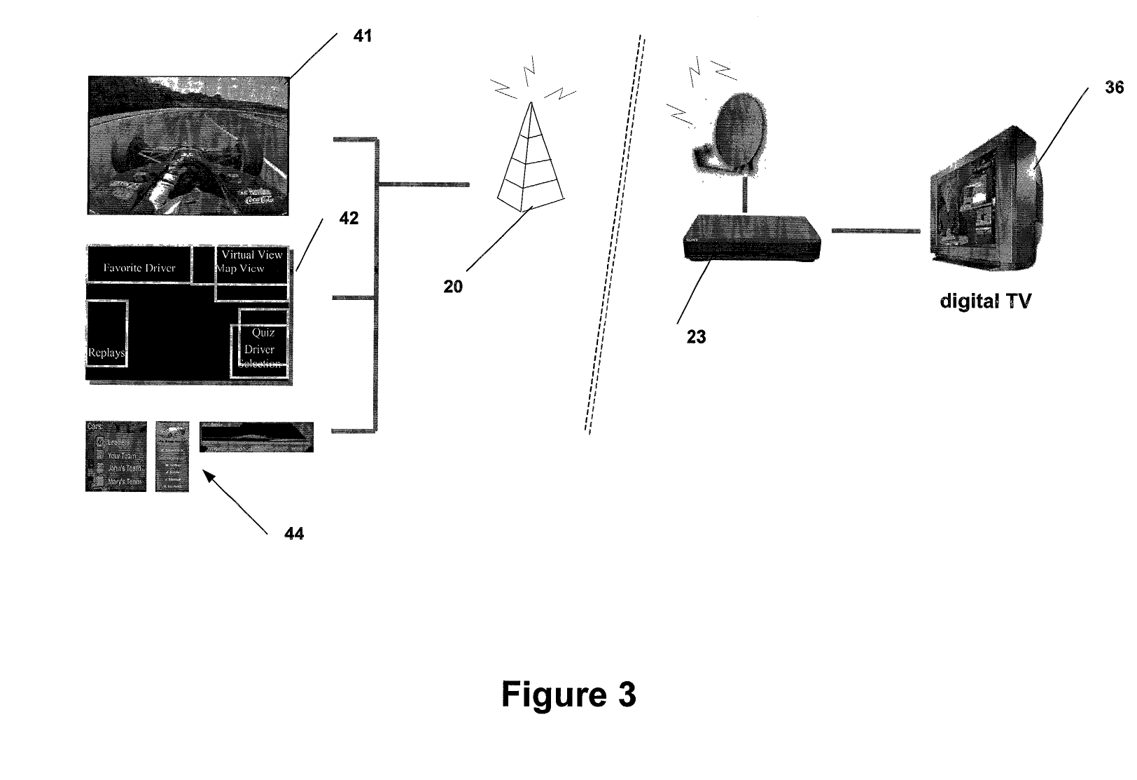

The Audio/Video (AV) elementary stream and the corresponding data may be delivered via cable or satellite or terrestrial broadcast as represented by the TV transmitter antenna 20. At the receiving end, a receiving unit (antenna, or cable receiver) delivers the signals to a Set Top Box (STB) 23. In alternative embodiments, a gaming platform used in combination with a digital tuner may comprise the receiving unit. Alternatively, other digital platforms may incorporated and host rendering engines that could be connected to a digital receiver and act in combination as the receiving unit. The STB 23 as disclosed by the present invention includes a tuner 26, a demultiplexer (Demux) 28 to demultiplex the incoming signal, a MPEG2 Decoder 30 to decode the incoming signal, a presentation engine 32 using a declarative representation language. In an alternative embodiment, an application module (not shown here) may be included as a separate or integral part of the presentation engine 32. The application module may interface with a gaming platform also not shown here. The presentation engine 32 processes the incoming AV signals and the corresponding data, and renders a composite image as requested, on the digital television 36 of FIG. 3.

FIG. 3 illustrates an example of the type of data communication between by the transmission and reception system of the present invention. On the transmission side 14, the broadcaster sends a combination of AV elementary stream data 41, data recognized by the receiver down the line as broadcaster created region definitions 42 and various event related assets 44 using the TV transmitter antenna 20. As used here, an asset refers to an event related camera view or data to be displayed on the user's screen. The event related assets may include race car performance data such as the racecar's engine RPM and speed, or may include the racecar driver's standing in the race, performance statistics of the pit crew, or other broadcaster defined data.

If the asset consists of event related data, such as performance data on individual race cars, the graphics associated with displaying the data may be generated by the broadcaster and transmitted to the viewer's receiver, or the graphics may generated down stream by a presentation engine residing on the viewer's receiver. It would be appreciated by one skilled in the art that asset graphics generation down stream reduces the amount of data that needs to be transmitted down stream and thus requires less bandwidth. In one embodiment of the present invention, the presentation engine rendering the accompanying graphics for each asset may be based on a declarative representation language such as an extension to the Virtual Reality Markup Language (VRML).

On the receiver side, the presentation engine 32 residing in the set top box 23, uses the elementary streaming video feed 41 and the related assets 44 to create a composite scene shown on the digital TV screen. The overlaying of the related assets on the elementary video feed is at least partially controlled by the asset region definitions 42 the scene the viewer sees on the digital TV 36. Furthermore, the presentation engine 32 automatically rearranges the screen layout based on the user preference input and taking into consideration the broadcaster's asset region definition.

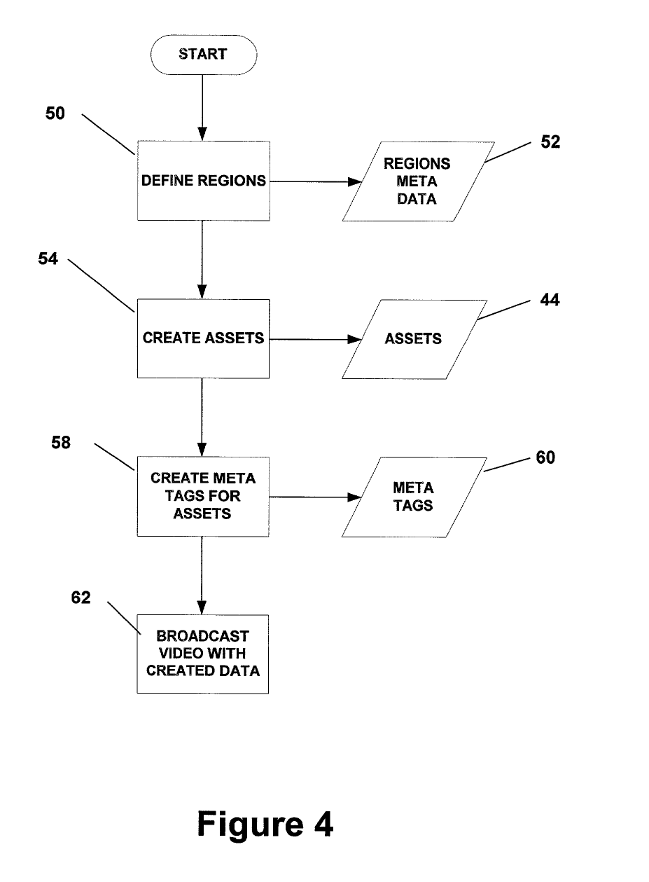

FIG. 4 is a flow diagram of one embodiment for the generation of a composite broadcast signal. In operation 50, the broadcaster defines a specific region for overlaying each of the assets on the video feed. In one embodiment, regions are defined using meta data and the assets displayed are associated with a defined region using meta tags. A meta tag is a tag (a coding statement) used in a markup language such as Virtual Reality Markup Language (VRML), that describes some aspect of the contents of the corresponding data. Meta tags are used to define meta data. In the most general terms, meta data is information about a document. In one embodiment, the broadcaster defines regions of asset overlay by creating meta data 52, and transmitting the meta tags down stream to the receiver 23. The receiver uses the meta data to create or define particular regions or placards used for displaying assets. The broadcaster may have preferences on how the screen layout should look like. For example, the broadcaster may be using certain regions of the TV screen for the display of broadcaster-defined messages such as an advertising message or a commercial logo. In operation 54, the broadcaster creates assets 44 that may be overlaid on the elementary video feed. The created assets may include such information as performance data for individual racecars. Sensors located on each racecar gather the information necessary to generate the assets and the broadcaster compiles all the sensor data and transmits the information down stream to the viewer. In an alternative embodiment, the graphics associated with each set of assets may be rendered by the presentation engine 32 residing on the receiver 23. In operation 58, the broadcaster creates meta tags 60 that associate the assets 44 to the region definitions. The meta tags 60 convey additional information about the assets to be rendered. This may include data used by the composition engine 32 to display particular assets in the corresponding defined regions. The resulting output of operation 58 is the creation of meta tags 60. In operation 62, the broadcaster transmits the elementary AV signal along with the meta data 52 used for region definition, the assets created 44 and the corresponding meta tags 60 to the receiver over satellite or broadband. In the present example, the video/data transmission is based on the ATSC standard. However, it would be appreciated by one skilled in the art that many other standards allowing for the transmission of the combined AV/data signal may be used.

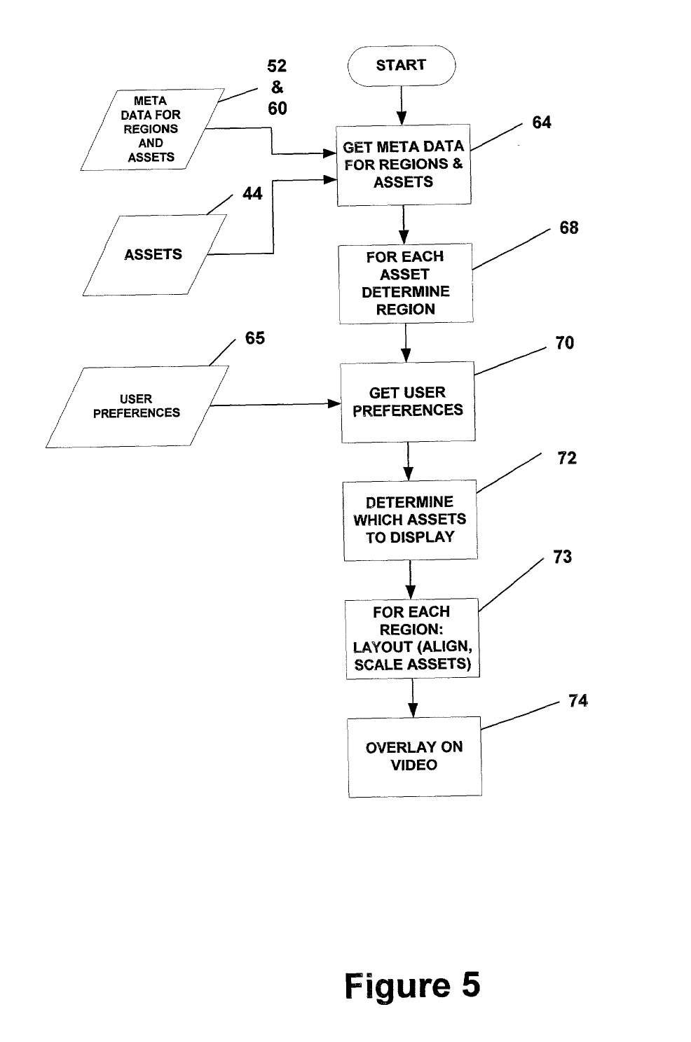

FIG. 5 is a diagram of one embodiment for the recovery of a composite broadcast signal illustration of the data flow on the receiver side. In operation 64, the presentation engine 32 residing on the receiver 23 receives the meta data 52 for region definition, meta tags 60 for assets definition, and association to the defined regions, and the assets 44 to be overlaid on the elementary video feed. As referred to here, an asset 44 refers to a camera view of an activity related to the broadcast event. A broadcast event may be covered by multiple camera views and thus multiple assets may be available for display on the viewer television screen, based on the viewer's selections. Furthermore, meta data 52 may be used by the broadcasters to define the display regions 42, whereas meta tags 60 may be used to associate a particular asset 44 with a particular display region 42. In operation 68, the meta data for regions definitions and meta tags for assets definitions are used to determine corresponding broadcaster defined region of display for each asset. In operation 70, the presentation engine 32 accepts the user preferences 65 as inputs in order to determine which assets to display. Since the ultimate goal of DTV is interactivity, once the enhancements are under the control of the viewer, it is essential to make these accessible through an intuitive interface. Television is typically a very passive experience and consumer acceptance will fall off as the interface strays from the simple button press on a remote control. Web-based content typically involves a mouse-driven cursor that can point to an arbitrary region of the screen and thus declarative representation languages such as VRML includes a Touch-Sensor node. However, in one embodiment, interactive television applications are driven by a ButtonSensor node which is adapted to accept input from devices such as a TV remote control. The buttons on the input devices such as PC keyboards, remote controls, game controller pad, etc. trigger this node. Below is an example of one ButtonSensor declaration:

ButtonSensor {

field SFString buttonOfInterest “Enter”
field SFTime pressTime 0
field SFTime releaseTime 0
field SFBool enabled TRUE

}

In an embodiment of the present invention, in implementing the presentation engine 32 using a declarative markup language such as VRML, in addition to the standard computer keyboard keys, the declarative presentation language has predefined a set of literal strings that are recognizable as values for the buttonOfInterest field. Depending on the type of the input device, these literal strings are then mapped to the corresponding buttons of the input device. For example, if the buttonOfInterest field contains the value of “REWIND”, the corresponding mapping key for a keyboard input device would translate to ‘←’, whereas on a TV remote it would map to the ‘<<’ button.

The design of the graphical user interface (GUI) for the present invention is based on the assumption that TV viewers are typically limited to four arrow buttons, a select button, and an exit button. Furthermore, for the most part the GUI interface of the present invention is based on the traditional 2-D menu-driven interface. Typically, the menu selections are located on the left side of the screen It would be apparent to one skilled in the art that other input devices and GUIs may be used to implement the method and apparatus of the present invention.

In operation 72, based partially on the user preferences and partially on the broadcaster predefined region definition and their association with the respective regions, the presentation engine 32 determines which assets to display in a particular region. In operation 73, based on the assets being displayed, the presentation engine 32 aligns and scales the assets in order to fit the layout on the screen. In operation 74, the scaled and aligned assets are overlaid on the video feed 41 and composited prior to displaying on the TV screen.

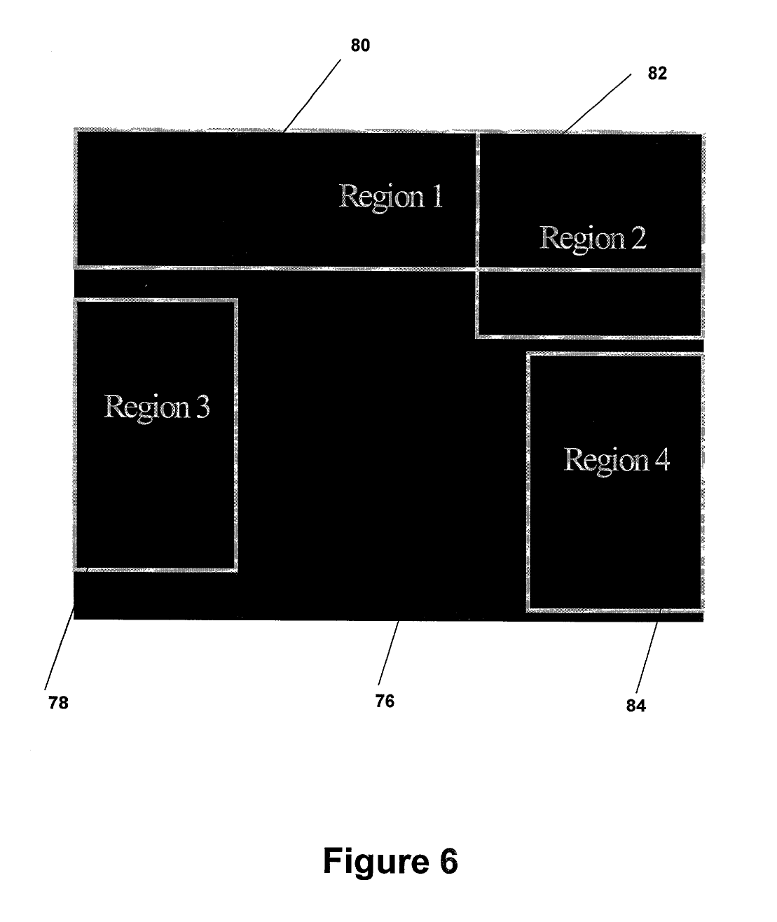

FIG. 6 is an example of one embodiment of the use of meta-data 52 for region definitions. Using meta data 52, the broadcaster transmits its desired region definitions to be used for displaying the viewer desired assets. The broadcasters may limit each region to be used for displaying the assets to regions 1 (78), region 2 (80), region 3 (82) and region 4 (84). The broadcaster may have preferences on which areas need to remain free from overlay for use by the broadcaster specific purposes such as displaying commercial messages. The broadcaster region definition may include the broadcaster's preferences in limiting the use of a particular region for the display of specific assets. An example of the use of meta data 52 used for region definition is as follows:

<PROGRAM_LAYOUT>

<TITLE>Cart Racing</TITLE>
<REGION>

<NAME>Region 1</NAME>
<POSITION>0,0</POSITION>
<TYPE>Data</TYPE>
<TYPE>Graphics</TYPE>

</REGION>
<REGION>

<NAME>Region 2</NAME>
<POSITION>0,1</POSITION>
<TYPE>Data</TYPE>
<TYPE>Graphics</TYPE>

</REGION>
<REGION>

<NAME>Region 3</NAME>
<POSITION>1,0</POSITION>
<TYPE>Video</TYPE>

</REGION>

As shown in this illustrative example, each region definition includes position parameters (“POSITION”) defining its location within the display screen, and type parameters defining the content that may be displayed in the particular region. Each region definition also includes a region name such as “Region 1” or “Region 2”.

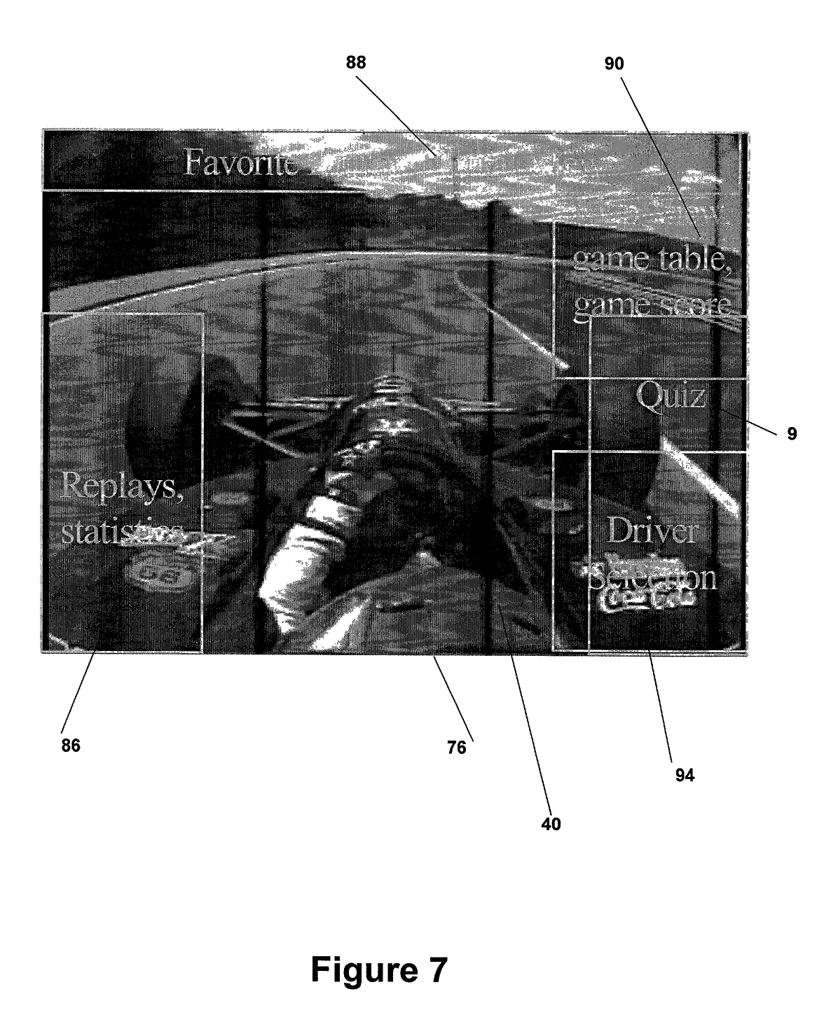

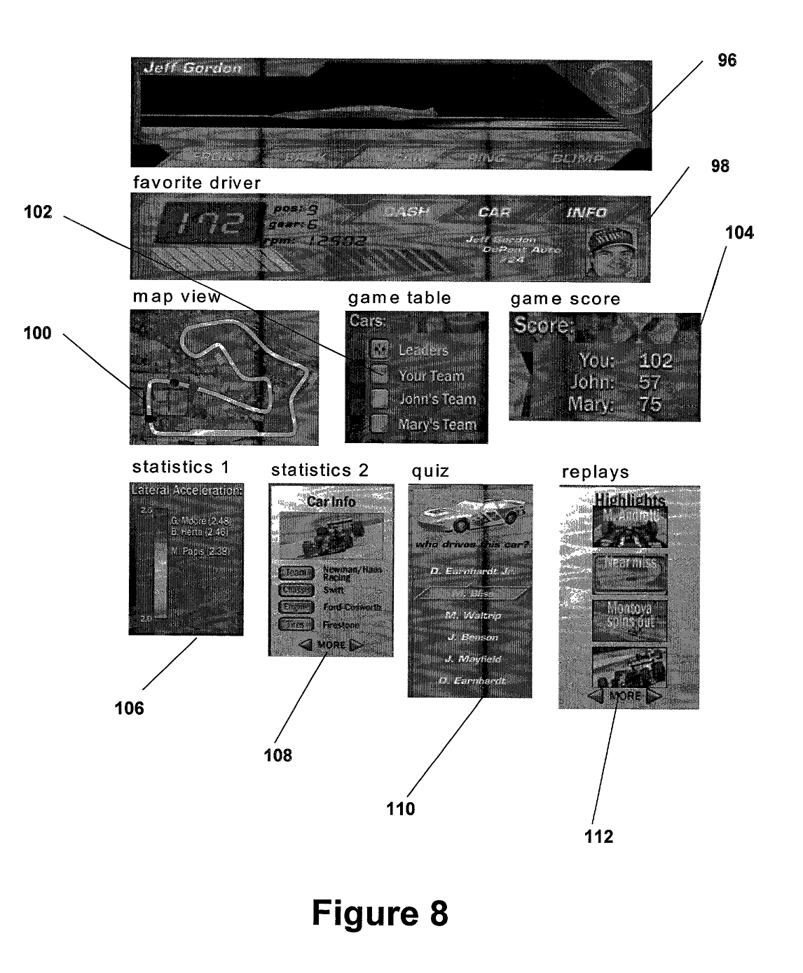

FIG. 7 is one embodiment for representative region definition layout for possible overlaying of assets on the live video feed. The background scene 76 is rendered using the elementary video feed 41. Overlaid on top of the AV feed 41, the meta data 52 are used to define each region used for the display of the assets 44 and meta tags 60 are used to correspond each defined region to a particular asset. Two or more assets may share a window or defined region. The meta tags 60 definition shown below is an illustrative example of how meta tags may be used to associate an asset with a particular region definition. In this example meta tags 60 for three of the assets of FIG. 8 are shown.

<ASSET>

<NAME>Virtual Viewer</NAME>
<ASSOCIATED REGION>Region 1
</ASSOCIATED REGION>
<TYPE>VRML</TYPE>
<ADDITIONAL DATA>Data Stream 2</ADDITIONAL

DATA>

<ADDITIONAL DATA>Data Stream 3</ADDITIONAL

DATA>

<LEVEL>Option 1</LEVEL>

</ASSET>
<ASSET>

<NAME>Telemetry for Favorite Driver</NAME>
<ASSOCIATED REGION>Region 1</ASSOCIATED

REGION>

<TYPE>VRML</TYPE>
<ADDITIONAL DATA>Data Stream 1</ADDITIONAL

DATA>

<LEVEL>Option 0</LEVEL>

</ASSET>
<ASSET>

<NAME>Map View</NAME>
<ASSOCIATED REGION>Region 2</ASSOCIATED

REGION>

<TYPE>VRML</TYPE>
<ADDITIONAL DATA>Data Stream 1</ADDITIONAL

DATA>

<LEVEL>Option 0</LEVEL>

</ASSET>

As shown in the example above, each asset meta tag may include a title for the asset, a region association relating the asset to the region within which the asset may be displayed, and type declarations declaring the type content that may be displayed in the placards or defined regions associated with each asset.

Accordingly, as shown in FIG. 7, region 86 may be used to display statistics and replays. Region 88 may be shared by two assets, “favorite driver” and the “virtual view”. The selection of a driver from the “favorite driver” asset may trigger the display of information specific to the selected driver, while the virtual view may display the favorite driver in a virtual view. Region 90 may be shared by the map view, the game table or game score. Region 92 overlapping regions 90 and 94 may be used for the quiz asset, and region 94 may be used for the driver selection menu. Since various regions overlap and because each region may be used to display multiple assets, the presentation engine 32 has to align and scale the assets to fit within the defined regions based on the viewer's selection of what he or she chooses to see.

FIG. 8 shows some examples of display renderings of some possible assets within the in a car race scenario broadcast. The “virtual view” asset 96 may allow the viewer to select a front, back TV camera, ring or blimp view of the ongoing race. The “favorite driver” asset 98 may display the viewer selected favorite driver car telemetry data such as the speed, engine RPM, the gear, and the driver standing within the race for each racecar as it continues along the race. The information necessary to produce this asset may be supplied by sensors 14 located on the particular race cars. In a preferred embodiment, the rendition of the graphics of the “favorite driver asset” may be composed locally, by the STB receiver 23.

The “map view” asset 100 may show a virtual aerial view of the race and particularly depicting the viewer selected racecars as they move around the race track. A “game table” asset displays a ranking of the racing teams and may allow several viewers to play against each other. In one embodiment of the present invention, the STB receivers 23 may be connected to each other via a wide area network such as the Internet. The “game score” asset 104 displays the game score between the game playing viewers. This score may span over several broadcast, wherein at the completion of each broadcast, the local STB boxes 23 would save the required data for reintroduction in the next broadcast.

The “statistics 1” asset 106 displays the performance statistics such as the lateral acceleration acting on each viewer selected racecar as they are moving around the track. The “statistics 2” asset 108 displays car information such as the type and size of engine used in the viewer selected racecar, the car chassis, the type of tires used and even the members of a particular race team.

The “quiz” asset 110 may present trivia questions of the viewer and the viewer responses may be used to keep scores and compared against other viewers, and displayed in the game score asset 104. The “replays” menu 112 allows the viewer to select replays on particular highlights such as a particularly difficult move by selected drivers. In the present example, the GUI interface is simple and very intuitive so as not to discourage viewers to use the various functionalities offered to them by the new digital TV technology.

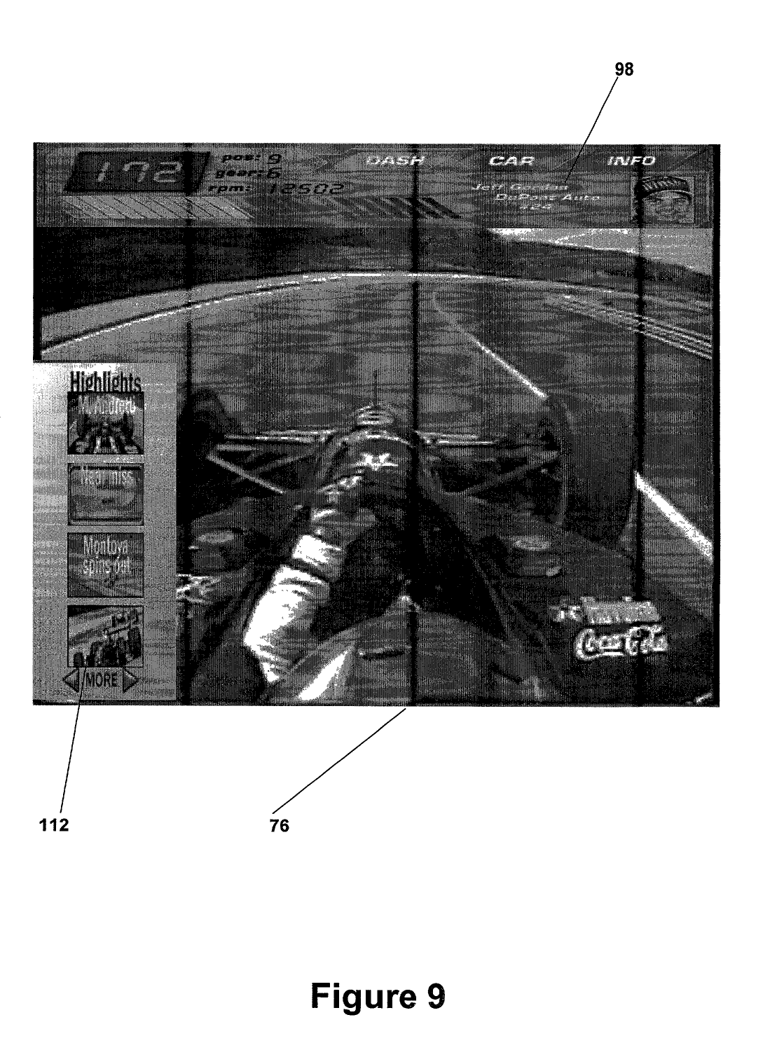

FIG. 9 is an example of a display rendering of the effect of the user preferences on the displaying of assets. In the upper region of the screen displaying the elementary video feed 76, the “favorite driver” asset 98 is displayed. In the left hand comer of the display screen, a menu of various replays 112 may be displayed. A table of the options selected by the viewer is shown below:

| | Config1 |
|---|---|
| Replays | Yes |
| Favorite | Yes |
| Virtual View | No |
| Favorite Driver | Gordon |
| Quiz | No. |

The user has inputted its preferences result in the selection and display of the Replays asset 112 and the Favorite driver 98 asset with Gordon as the favorite racecar driver to be tracked. The Virtual View asset 96 is not selected and thus not displayed.

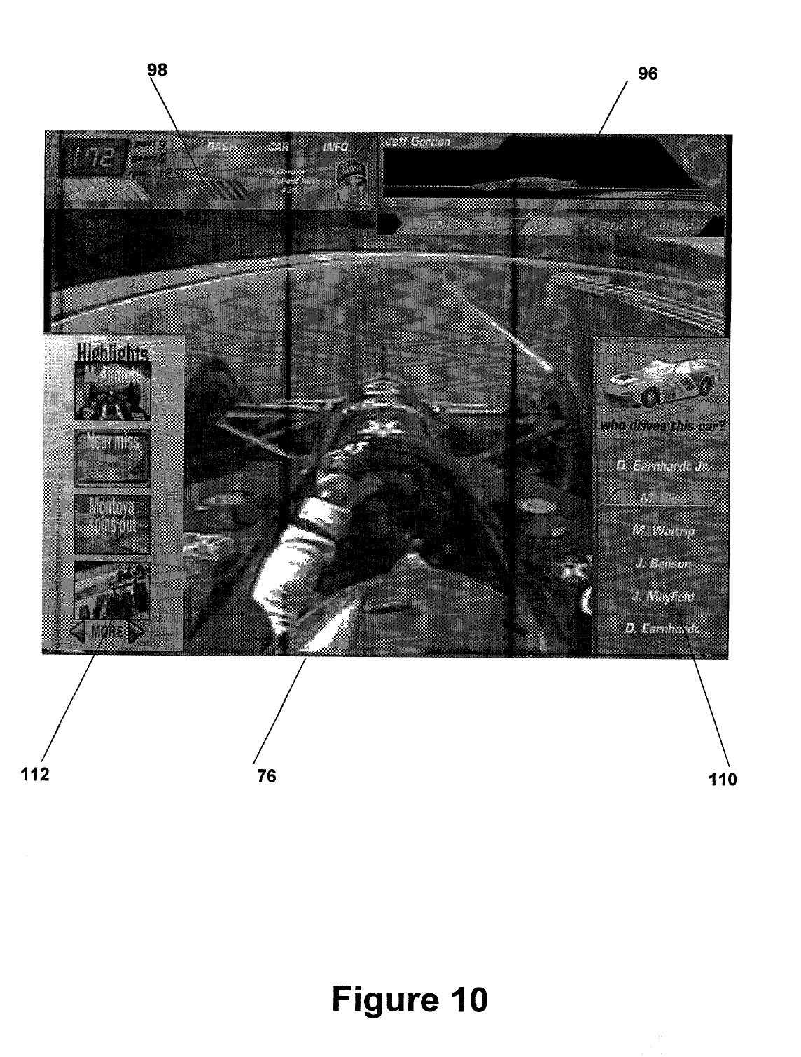

FIG. 10 is another example of a display rendering of the effect of the user preferences on the displaying of assets. In this configuration, overlaid upon the elementary video feed 76, based on the user preferences 65, the “favorite driver” asset 98 and the “virtual view” asset 96 are sharing the upper placard region defined for use by both assets. In the lower left hand comer of the screen, the “replays” menu 112 is still displayed and in the right hand comer of the screen, the “quiz” asset 110 is displayed. The Config 2 table below illustrates the viewer preferences selected for the current display (as shown in FIG. 10):

| | Config 2 |
|---|---|
| Replays | Yes |
| Favorite | Yes |
| Virtual View | Yes |
| Favorite Driver | Gordon |
| Quiz | Yes |

In the current scenario, the viewer preference inputs result in the selection and display of the Favorite Driver 98, the Virtual View asset 96, the Replay asset 112 and the Quiz asset 110. Since the upper region or region 1 is shared by both the Favorite Driver asset 98 and the Virtual View asset 96, each asset is scaled and adjusted to fit in the defined region.

Although the present invention has been described above with respect to presently preferred embodiments illustrated in simple schematic form, it is to be understood that various alterations and modifications thereof will become apparent to those skilled in the art. It is therefore intended that the appended claims to be interpreted as covering all such alterations and modifications as fall within the true spirit and scope of the invention.

What is claimed is:

1. A method of automatically displaying multiple assets on a screen comprising:
receiving a composite video feed, the composite video feed including a plurality of assets;
obtaining user preference data to determine which of the plurality of assets to display on each of a plurality of display regions;
aligning and scaling assets to be displayed in corresponding display regions according to the obtained user preference data; and
displaying the aligned and scaled assets with the elementary video feed.

2. The method of claim 1 wherein the composite video feed comprises meta data and meta tags associated with the plurality of assets.

3. The method of claim 2 further comprising:
defining the plurality of display regions using the meta data.

4. The method of claim 2 wherein the meta tags are used to align the plurality of assets within the plurality of display regions.

5. The method of claim 1 wherein the obtained user preferences are inputted via a television remote control.

6. The method of claim 1 wherein the obtained user preferences are inputted via a keyboard.

7. The method of claim 1 wherein a broadcaster provides and transmits the data content for each asset to be displayed along with the elementary video feed.

8. The method of claim 1 wherein a presentation engine residing on the receiver renders at least some graphics for display with each asset.

9. The method of claim 8 wherein the presentation engine is based on a declarative markup language such as VRML.

10. The method of claim 1 wherein at least one asset may be displayed based on definition by a broadcaster and independent of the received user preferences.

11. An apparatus for automatically displaying multiple assets on a screen comprising:
means for receiving a composite video feed, the composite video feed including a plurality of assets;
means for obtaining user preference data to determine which of the plurality of assets to display on each of a plurality of display regions;
means for aligning and scaling assets to be displayed in corresponding display regions according to the obtained user preference data; and
means for displaying the aligned and scaled assets with the elementary video feed.

12. The apparatus of claim 11 wherein the composite video feed comprises meta data and meta tags associated with the plurality of assets.

13. The apparatus of claim 12 further comprising:
defining the plurality of display regions using the meta data.

14. The apparatus of claim 12 wherein the meta tags are used to align the plurality of assets within the plurality of display regions.

15. The apparatus of claim 11 wherein the obtained user preferences are inputted via a television remote control.

16. The apparatus of claim 11 wherein the obtained user preferences are inputted via a keyboard.

17. The apparatus of claim 11 wherein a broadcaster provides and transmits the data content for each asset to be displayed along with the elementary video feed.

18. The apparatus of claim 11 wherein a presentation engine residing on the receiver renders at least some graphics for display with each asset.

19. The apparatus of claim 18 wherein the presentation engine is based on a declarative markup language such as VRML.

20. The apparatus of claim 11 wherein at least one asset may be displayed based on definition by a broadcaster and independent of the received user preferences.

21. A computer program product embodied in a computer readable medium for automatically displaying multiple assets on a screen comprising:
code means for receiving a composite video feed, the composite video feed including a plurality of assets;
code means for obtaining user preference data to determine which of the plurality of assets to display on each of a plurality of display regions;
code means for aligning and scaling assets to be displayed in corresponding display regions according to the obtained user preference data; and
code means for displaying the aligned and scaled assets with the elementary video feed.

22. The apparatus of claim 21 wherein the composite video feed comprises meta data and meta tags associated with the plurality of assets.

23. The method of claim 22 further comprising:
defining the plurality of display regions using the meta data.

24. The computer product of claim 22 wherein the meta tags are used to align the plurality of assets within the plurality of display regions.

25. The computer product of claim 21 wherein the obtained user preferences are inputted via a television remote control.

26. The computer product of claim 21 wherein the obtained user preferences are inputted via a keyboard.

27. The computer product of claim 21 wherein a broadcaster provides and transmits the data content for each asset to be displayed along with the elementary video feed.

28. The computer product of claim 21 wherein a presentation engine residing on the receiver renders at least some graphics for display with each asset.

29. The computer product of claim 28 wherein the presentation engine is based on a declarative markup language such as VRML.

30. The computer product of claim 21 wherein at least one asset may be displayed based on definition by a broadcaster and independent of the received user preferences.

31. A system for automatically displaying multiple assets on a screen comprising:
means for generating an elementary video feed, a plurality of assets, meta data determining a plurality of region definitions, meta tags associating at least one of a plurality of assets with a region definition;
means for transmitting the elementary video feed, the plurality of assets, the meta data, and the meta tags associating at least one of a plurality of assets with a region definition;
means for receiving a composite video feed, the composite video feed including a plurality of assets;
means for obtaining user preference data to determine which of the plurality of assets to display on each of a plurality of display regions;
means for aligning and scaling assets to be displayed in corresponding display regions according to the obtained user preference data; and
means for displaying the aligned and scaled assets with the elementary video feed.

32. A method of automatically displaying multiple assets on a screen comprising:
receiving an elementary video feed, a plurality of assets, meta data determining a plurality of display regions, and meta tags associating each display region with at least one of the plurality of assets;
obtaining user preference data and using the obtained user preference data to determine which of the plurality of assets to display in each display region;
aligning and scaling assets to be displayed in corresponding display regions according to the obtained user preference data, meta data and meta tags; and
displaying the aligned and scaled assets with the elementary video feed.
